(19) United States
(12) Patent Application Publication
(10) Pub. No.: US 2004/0088563 A1
(43) Pub. Date: May 6, 2004

(54) Computer access authorization

(76) Inventors: Dirk J. Hogan, Columbia, MO (US); David Cox, Santa Barbara, CA (US)

Correspondence Address: HEWLETT-PACKARD COMPANY, Intellectual Property Administration, P.O. Box 272400, Fort Collins, CO, 80527-2400, US

(21) Appl. No.: 10/286,720

(22) Filed: Nov. 1, 2002

(51) Int. Cl. H04L 9/00

(52) U.S. Cl. 713/200

(57) ABSTRACT

A method for controlling access to functionality in an application program according to one embodiment includes registering at least one permission set in a database. The permission set includes a plurality of privileged actions relating to a functional category of the application program. The method further includes receiving information granting a principal authorization to at least one of the privileged actions in the permission set, and performing the authorized privileged action in accordance with the received information when initiated by the principal.

### BACKGROUND OF THE INVENTION

In many computer applications, access to certain functionality is limited to authorized users. This is typically accomplished by associating an access control list with each protected object (i.e., each object whose functionality is subject to authorization constraints). The access control list defines the specific users authorized to access the corresponding protected object, as well as the specific actions for which each such user has been authorized. Entries in each list typically consist of the tuple <principal, bits> where the “principal” is the user or group, and the “bits” identify those actions for which the user has been authorized relative to this particular protected object.

As recognized by the inventors hereof, it is sometimes cumbersome to create an access control list for each protected object, particularly when it would be advantageous to grant a user authorization for performing an action whose execution requires access to multiple protected objects.

### SUMMARY OF THE INVENTION

To solve these and other needs in the prior art, the inventors hereof have succeeded at designing a system and methodology which allows authorization information for multiple protected objects to be commonly stored. The inventors have also succeeded at developing a system and methodology whereby users may be authorized to perform an action throughout a predefined functional category of an application program.

According to one embodiment of the present invention, a method for controlling access to functionality in an application program includes registering at least one permission set within the application program. The permission set includes a plurality of privileged actions relating to a functional category of the application program. The method further includes receiving information granting a principal authorization to at least one of the privileged actions in the permission set, and performing the authorized privileged action in accordance with the received information when initiated by the principal.

Further areas of applicability of the present invention will become apparent from the detailed description provided below. It should be understood that the detailed description and specific examples, while indicating exemplary embodiments of the invention, are for purposes of illustration only and should not be construed as limiting the scope of the invention.

### BRIEF DESCRIPTION OF THE DRAWINGS

The present invention will become more fully understood from the detailed description and accompanying drawings, wherein:

FIG. 1 is a block diagram of a computer network in accordance with one embodiment of the present invention;

FIG. 2 illustrates various data structures used by the authorization and authentication (A&A) module shown in FIG. 1 in accordance with another embodiment of the present invention;

FIG. 3 illustrates an Access Control List (ACL) utilized by the A&A module shown in FIG. 1 in accordance with another embodiment of the present invention;

FIG. 4 illustrates another embodiment of an ACL;

FIG. 5 illustrates yet another embodiment of an ACL;

FIG. 6 is a simplified flow chart of the steps performed in one embodiment of the present invention; and

FIG. 7 is a simplified flow chart of the steps performed in another embodiment of the present invention.

### DETAILED DESCRIPTION OF EXEMPLARY EMBODIMENTS

The present invention is applicable to any computer system or application which manages user access to some or all of its functionality. Although exemplary embodiments of the invention are described below with reference to computer networks and storage area networks (SAN), those skilled in the art will recognize that the scope of the invention is not so limited, and can also be applied, for example, to standalone computer devices and applications.

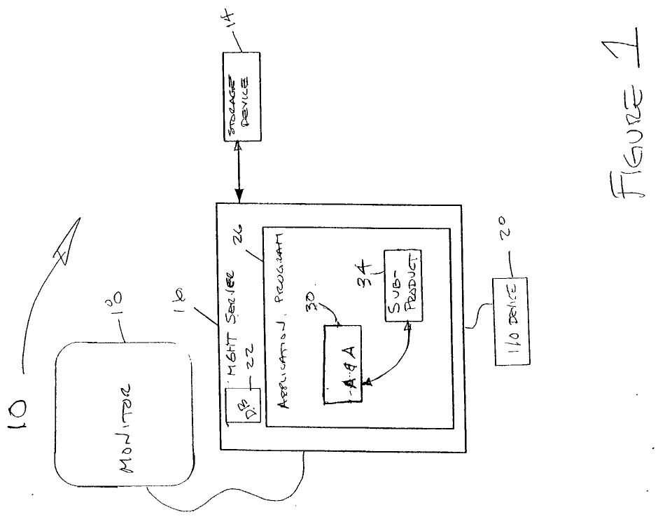

Referring to FIG. 1, a computer-based network 10 is shown which includes a management server 12 that is associated with a storage device 14. In one embodiment, the storage device 14 resides remotely from management server 12, as shown in FIG. 1. For example, storage device 14 can reside on a SAN associated with management server 12. Alternatively, management server 12 could include storage device 14. The management server 16 can be any computer-based device capable of performing server functions. For example, the management server 16 can be a single computer or a network server connected to a plurality of computers. The management server 16 preferably includes a monitor 18 for viewing information, data and graphics, a user input device 20, such as a keyboard, touch screen, or a mouse, and a database 22.

The management server 16 includes an application program 26 that is used to manage data stored in the storage device 14. For example, the application program 26 can be a storage area manager (SAM) application used to manage storage and resources of a SAN. The application program 26 includes an authorization and authentication (A&A) module 30 and at least one sub-product 34 (e.g., an add-in component). The A&A module 30 controls access by a user to functionality provided by the application program 26, including the sub-product 34.

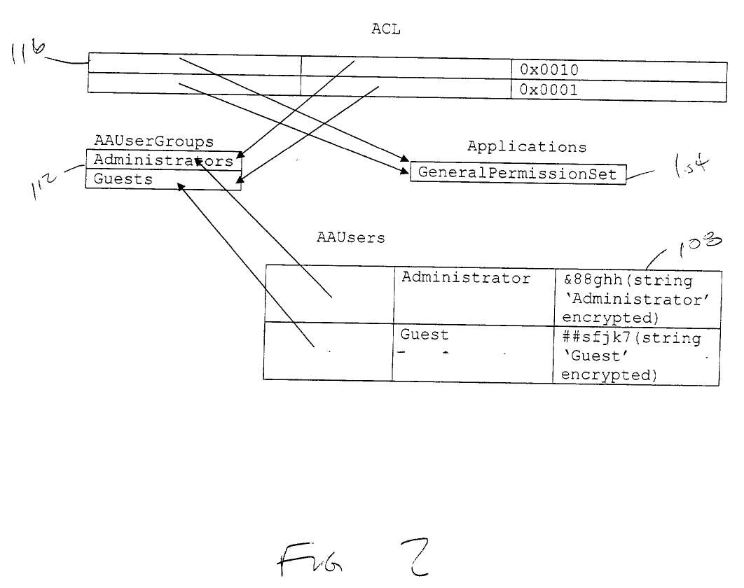

FIG. 2 illustrates various data structures stored in the database 22 by the A&A module 30 in accordance with one embodiment of the present invention. The A&A module 30 utilizes predefined sets of privileged actions (i.e., actions whose performance is subject to authorization constraints) relating to one or more functional categories of the application program 26, referred to herein as “permissions sets,” to control access to the application's functionality.

In one embodiment, a single permission set, referred to as GeneralPermissionSet, is implemented for the entire application program 26 including privileged actions supported by the sub-product 34. The GeneralPermissionSet is stored in an Applications data structure 104 stored in the database 22. The GeneralPermissionSet defines two broad privileges; the ability to READ and the ability to READ_WRITE. Users with the former privilege can access information in storage device 14, but cannot configure information within the storage device 14. Users with the latter privilege can both access and configure information stored in the storage device 14.

To enforce the two permissions defined in the GeneralPermissionSet, the A&A module 30 initializes the database 22. This is done utilizing an AAUsers data structure 108 and an AAUsersGroup data structure 112, which reside in the database 22. The A&A module 30 creates two default user groups, an Administrators group and a Guests group, and stores the groups in the AAUsersGroup data structure 112. Users belonging to the Administrators group have READ_WRITE privileges with respect to the application program 26 and all the components (including sub-products) of the application program 26. Users belonging to the Guests group have only READ privileges with respect to the application program 26 and its various components. As described further below, each user of system 10 is assigned to at least one group and enjoys all the privileges associated with that group. The A&A module 30 stores the names of users of system 10 and the group(s) to which each user has been assigned in the database table 108.

Initially, the AAUsers data structure 108 contains two default users; an ‘Administer’ that belongs to the Administrator group, and a ‘Guest’ that belongs to the Guest group. These default users allow a system administrator to configure the A&A module 30 subsequent to its installation. As described further below, subsequent to initialization by A&A module 30, the system administrator inputs information that A&A module 30 uses to create entries in an access control list (ACL) data structure 116. For example, based on input from the system administrator, the A&A module 30 creates an entry including the Administrator group, an entry including the Guest group, and an entry including the sub-product 34 in ACL 116. Creating entries including the user groups and sub-product 34 in ACL 116 grants the Administrators groups READ_WRITE privileges in the context of the application product 26, and grants the Guests group READ privileges in the context of the application product 26.

In another embodiment, the A&A module 30 is adapted to allow at least one sub-product 34 to define and enforce privileged actions that can be exercised in the context of the sub-product 34. Additionally, the A&A module 30 is adapted to support protected object classes. A protected object class defines a permission set that is composed of a set of actions that can be exercised on a particular instance of the protected object class. Furthermore, a protected object class defines the semantics of the actions defined in the permission set.

When a sub-product 34 is allowed to define and enforce privileged actions that can be exercised in the context of the sub-product 34, the Applications data structure 104 will contain multiple entries. For example, Applications data structure 104 would contain the GeneralPermissionSet and a permission set specific to sub-product 34, for example SubProdPermissionSet. The sub-product permission set is registered in the database 22 and state information identifying the sub-product permission set is stored in Applications database table 104 when the sub-product 34 is installed. During installation, the sub-product 34 utilizes the A&A module 30 to register the sub-product permission set and store the sub-product permission set state information in the Applications data structure 104.

As described further below, subsequent to registration of the sub-product permission set, the system administrator can input information that the A&A module 30 will use to create entries in the ACL data structure 116. For example, based on input from the system administrator, the A&A module 30 may create entries in the ACL 116 that authorize at least one principal to perform at least one specific privileged action included in the sub-product permission set.

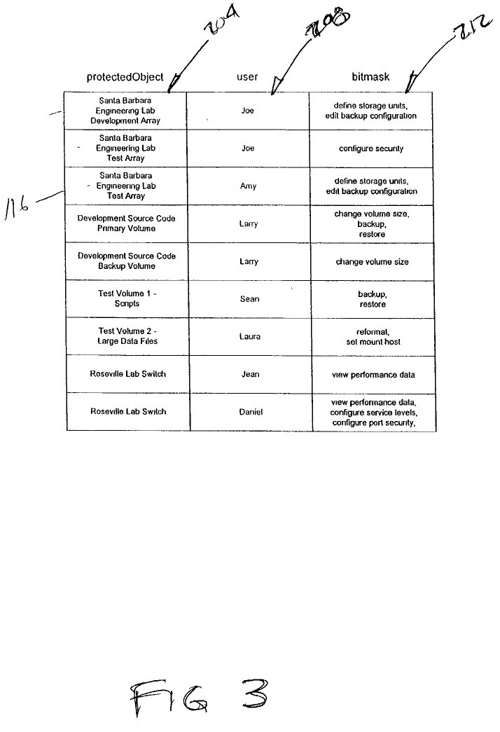

FIG. 3 illustrates an ACL 116 utilized by the A&A module 30 in one embodiment wherein the A&A module 30 utilizes a single data structure, i.e., the ACL 116, to list a plurality of protected objects and the privileged actions that can be exercised against each protected object. More specifically, the ACL 116 defines specific actions a user can exercise against a particular protected object. Entries in the ACL 116 include a protected object identifier 204, a principal (i.e., a user or group of users) identifier 208, and a bitmask 212. The protected object identifier 204 is a reference to an object to which access is controlled. For example, the protected object identifier 204 can represent a physical or logical resource external to the application program 26, such as an interconnect device included in the storage device 14, or the protected object identifier 204 can represent an object class within the application program 26, such as files, directories or network connections, or the protected object identifier 204 can represent a service provided by the application program, such an E-mail service or an event exporting service.

In one embodiment, the protected object identifier 204 and the principal identifier 208 are entered in the ACL 116 using numeric coding, while bitmask 212 is implemented using a 64-bit integer. However, any suitable identifier scheme or code interpretable by system 10 can be employed. For exemplary purposes, the entries in FIG. 3 are shown in alpha text as opposed to data codes and bitmasks.

The principal identifier 208 is a reference to an object representing a principal whose access to the protected object identified by the protected object identifier 204 is controlled. The principal can either be a single user or a group of users. Bitmask 212 is a bit-field in which individual data bits are set that represent the access to the protected object identified by the protected object identifier 204 which the principal identified by the principal identifier 208 is allowed to perform. The semantic meaning of the bits in the bitmask 212 are defined by the class or category of the object represented by the protected object identifier 204.

For exemplary purposes only, FIG. 3 illustrates the ACL 116 as it might be utilized in a SAM application. One exemplary entry shown in FIG. 3 would allow a user ‘Joe’ to ‘define storage units’ and ‘edit a backup configuration’ for the storage array ‘Santa Barbara Engineering Lab Array’.

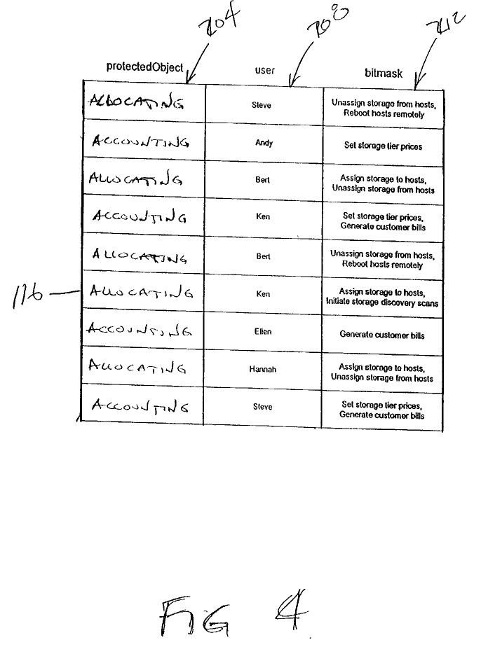

FIG. 4 illustrates the ACL 116 utilized by the A&A module 30 in accordance with another embodiment in which the A&A module 30 is adapted to allow at least one sub-product 34 to register one or more permission sets. For exemplary purposes, the entries in FIG. 4 are shown in alpha text as opposed to data codes and bitmasks, as noted above. In this embodiment, the A&A module 30 utilizes the single data structure, i.e. ACL 116, to allow the sub-product 34 to grant principals broad, categorical privileges not focused on individual objects. For example, the protected object identifier 204 can represent a sub-product 34, wherein performance of the privileged action identified in the bitmask 212 requires access to multiple objects within the sub-product 34 and/or the application program 26. The A&A module 30 categorizes each sub-product 34 and each sub-product registers a permission set for each of these created categories, resulting in privilege categories. For example, an ‘Accounting’ sub-product 34 might define a permission set which includes the actions ‘set storage tier prices’ and ‘assign storage to hosts’. Each of the actions correspond to a specific bitmask 212 that defines the privileges the principal identified by principal identifier 208 must be authorized to have in order to carry out the specified actions ‘set storage tier prices’ and ‘assign storage to hosts’. Thus, the A&A module 30 models, i.e. represents, the sub-product privilege categories as protected objects identified by protected object identifiers 204 in ACL 116.

When a sub-product 34 registers a permission set defining a set of privileged actions, the sub-product 34 also registers corresponding programming state that is adapted to interpret the various bitmasks 212. This programming state has an identifier which is placed in the database 22 as a protected object. Therefore, the protected object identifier 204, of a sub-product related entry in ACL 116, points to a corresponding programming state identifier, i.e. protected object, stored in the database 22. The programming state identifier is used to identify programming state which provides semantic meaning to the bitmask 212 of the ACL 116 entry.

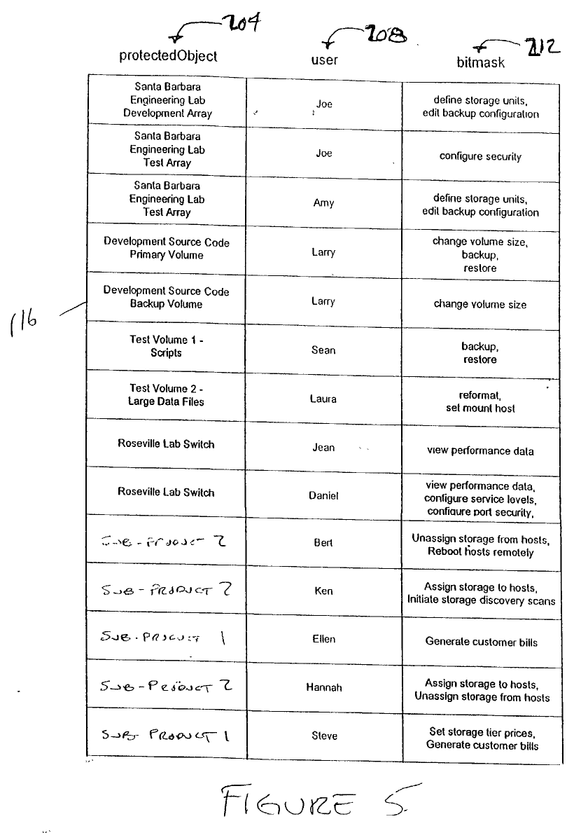

FIG. 5 illustrates the ACL 116 in accordance with another embodiment in which the A&A module 30 is adapted to allow at least one sub-product 34 to register a sub-product permission set and further adapted to list a plurality of protected objects and the privileged actions that can be exercised against each object. Therefore, both permission sets and protected objects are treated in similar fashion. For exemplary purposes, the entries in FIG. 5 are shown in alpha text as opposed to data codes and bitmasks, as described above. As illustrated, ACL 116 can include entries having protected object identifiers 204 that identify specific sub-product privileged categories and/or entries that identify specific objects such as engineering lab arrays. The bitmasks 212 corresponding to specific objects identify privileged actions defined by the application program 26, while the bitmasks 212 in the sub-product entries identify privileges defined in the context of the specific sub-product 34. The sub-product privileges are not defined relative to a particular type of object permission, but rather are defined in the context of the particular sub-product 34.

More specifically, each sub-product 34 defines the permission set that specifies the privileged actions which can be exercised in the context of the particular sub-product 34. The permission sets do not fall into an object permission type, but rather are defined relative to the semantics of the particular sub-product 34. Each sub-product 34 is adapted to register these permission sets utilizing the A&A module 30 and to enforce the permissions. The A&A module 30 creates the privileged categories that includes the permission sets defined by each sub-product 34, then models each privileged category as a protected object in the ACL 116. In other words, the permission set defined by each sub-product 34 is treated as a protected object whose accessibility must be limited, and secured. The nature of these limitations is determined by the individual permissions defined within the permission set. The permission set as a whole is represented as a category that is modeled as a protected object in the ACL 116, which is stored in database 22. Access to this ‘modeled’ protected object is determined by the permissions enjoyed by a principal in the context of the particular sub-product 34. Thus, the A&A module 30 allows entries in ACL 116 to define who can do what to one or more objects within the sub-product. It also allows permission sets to be dynamically registered and the permissions defined therein enforced. Additionally, all access control information for all sub-product categories and object classes is stored in a single data structure, i.e. ACL 116.

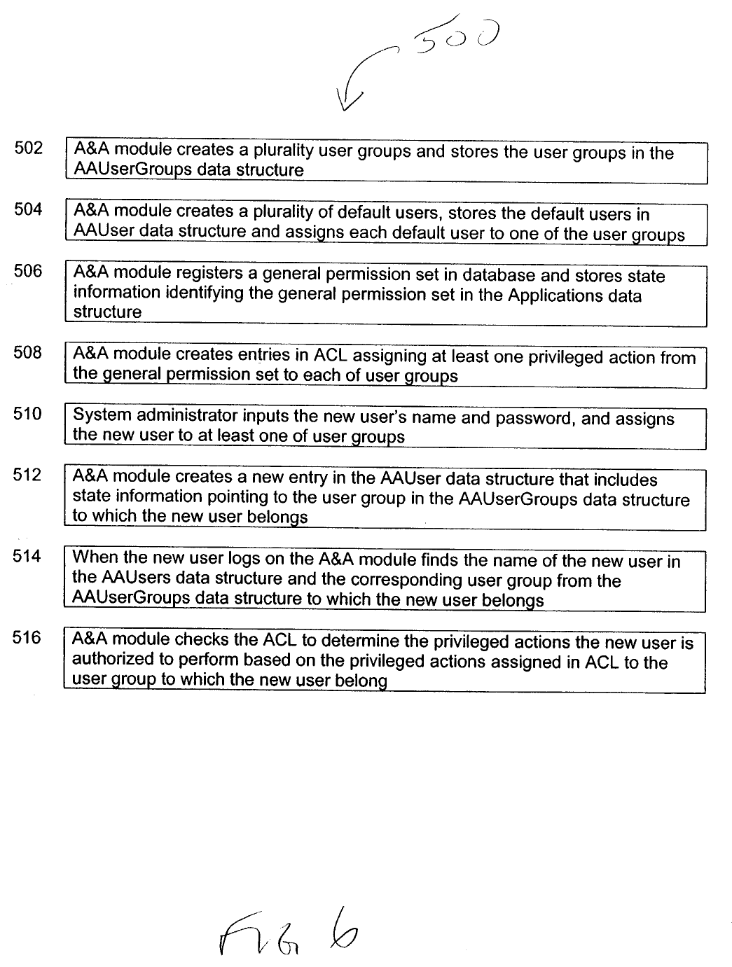

FIG. 6 is a simplified flow chart 500 of the steps performed in one embodiment of the present invention. When the A&A module 30 is first loaded the A&A module 30 creates a plurality of user groups and stores the user groups in the AAUserGroups data structure 108, as indicated at step 502. Additionally, the A&A module 30 creates a plurality of default users, stores the default users in AAUser data structure 108 and assigns each default user to one of the user groups, thereby assigning each default user all the privileges that correspond to the assigned user group, as indicated at step 504. Furthermore, the A&A module 30 registers a general permission set in database 22 and stores state information identifying the general permission set in the Applications data structure 104, as indicated at step 506. The general permission set includes privileged actions that apply to the entire application program 26 and all the functional categories included in the application program 26, for example any sub-product 34 that may be subsequently loaded.

The A & A module 30 then creates entries in ACL 116 by assigning at least one privileged action from the general permission set to each of the user groups, as indicated at step 508. Thus, the protected object identifier 204 of each entry contains state information identifying the general permission set in the Applications table 104, the principal identifier 208 contains state information identifying one of the user groups in the AAUserGroups data structure 112, and the bitmask 212 identifies the one or more privileged actions the user group identified by the principal identifier 208 of the same entry is authorized to perform within the application program 26 and/or any sub-product 34.

When the system administrator desires to create a new user, using input/output device 20 and a graphical user interface (not shown) displayed on monitor 18, the system administrator inputs the new user's name and password, and assigns the new user to at least one of user groups, as indicated at step 510. The A&A module 30 then uses the information input by the system administrator to create a new entry in the AAUser data structure 108 that includes state information pointing to the user group in the AAUserGroups data structure to which the new user belongs, as indicated at step 512. Thus, when the new user logs on to system 10, the A&A module 30 finds the name of the new user in the AAUsers data structure 108 and the corresponding user group from the AAUserGroups data structure 112 to which the new user belongs, as indicated at step 514. The A&A module then checks the ACL 116 to determine the privileged actions the new user is authorized to perform based on the privileged actions assigned in the ACL 116 to the user group to which the new user belongs, as indicated at step 516.

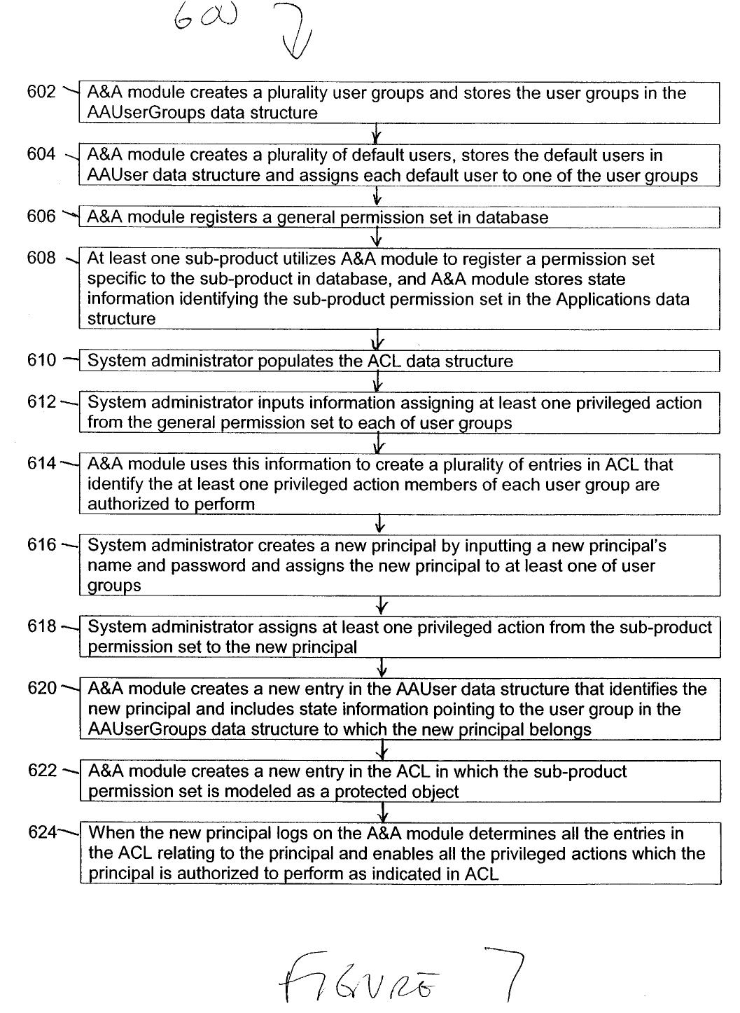

FIG. 7 is a simplified flow chart 600 of the steps performed in another embodiment of the present invention. When the A&A module 30 is first loaded, it creates a plurality of user groups and stores the user groups in the AAUserGroups data structure 108, as indicated at step 602. Additionally, the A&A module 30 creates a plurality of default users, stores the default users in the AAUser data structure 108 and assigns each default user to one of the user groups, thereby assigning each default user all the privileges that correspond to the assigned user group, as indicated at step 604. Furthermore, the A&A module 30 registers a general permission set in the database 22 and stores state information identifying the general permission set in the Applications data structure 104, as indicated at step 606. The general permission set includes privileged actions that apply only to the core functions of application program 26 and require access to a single object.

Subsequently, at least one sub-product 34 utilizes the A&A module 30 to register a permission set specific to the sub-product 34 in database 22, and A&A module 30 stores state information identifying the sub-product permission set in the Applications data structure 104, as indicated at step 608. The sub-product permission set includes privileged actions that apply only to the sub-product 34 and require access to multiple objects.

The system administrator then populates the ACL data structure 116 by using input/output device 20 and a graphical user interface (not shown) displayed on monitor 18, as indicated at step 610. The system administrator inputs information assigning at least one privileged action from the general permission set to each of user groups, as indicated at step 612. The A&A module 30 uses this information to create a plurality of entries in ACL 116 that identify the at least one privileged action members of each user group are authorized to perform, as indicated at step 614.

To assign sub-product related privileges the system administrator creates a new principal, i.e. one or more users, by inputting a new principal's name and password and assigns the new principal to at least one of user groups, as indicated at step 616. Next, the system administrator assigns at least one privileged action from the sub-product permission set to the new principal, as indicated at step 618. The A&A module 30 then uses the information input by the system administrator to create a new entry in the AAUser data structure 108 that identifies the new principal and includes state information pointing to the user group in the AAUserGroups data structure to which the new principal belongs, as indicated at step 620. Additionally, the A&A module 30 creates a new entry in the ACL 116 in which the sub-product permission set is modeled as a protected object, as indicated at step 622. Thus the protected object identifier 204 contains state information identifying the sub-product permission set. Additionally, the principal identifier 208 and the bitmask 212 of the new entry respectively contain state information identifying the principal, and privileged actions which the principal is authorized to perform in the context of the sub-product. Thus, when the new principal logs on to system 10, the A&A module 30 determines all the entries in the ACL 116 relating to the principal and enables all the privileged actions which the principal is authorized to perform as indicated in ACL 116 as indicated at step 624. These privileged actions can be actions the principal is authorized to perform as a member of a user group, or actions the principal is authorized to perform in the context of the sub-product.

Alternatively, the system administrator can input information to create at least one security group in the AAUserGroups data structure 112 and assign at least one sub-product privileged action from the sub-product permission set to the security group. The A&A module 30 then creates an entry in ACL 116, wherein the principal identifier 208 identifies the security group, the protected object identifier 204 identifies the entry in the Applications table 104 corresponding to the sub-product permission set, and the bitmask 212 identifies the at least one sub-product privileged action. The system administrator then assigns a new principal to the security group. The new entry contains state information corresponding to the sub-product permission set, an entry in the AAUser data structure 208, and at least one privileged action the security group is authorized to perform. Thus, when the new principal logs on the A&A module 30 determines all the entries in the ACL 116 relating to the principal and enables all the privileged actions which the principal is individually authorized to perform and all the privileged actions which the security group to which the principal belongs is authorized to perform as indicated in ACL 116.

Thus, the protected object identifier 204 of each entry would contain state information identifying a permission set in the Applications table 104, the principal identifier 208 would contain state information identifying one of the user groups in the AAUserGroups data structure 112, and the bitmask 212 would identify the one or more privileged actions the user group identified by the principal identifier 208 of the same entry is authorized to perform within the application program 26 and/or any sub-product 34.

The above description of exemplary embodiments is merely illustrative in nature and, thus, variations that do not depart from the gist of the invention are intended to be within the scope of the invention. Such variations are not to be regarded as a departure from the spirit and scope of the invention.

What is claimed:

1. A method for controlling access to objects in an application program, the method comprising storing authorization information for a plurality of protected objects in a common table.

2. The method of claim 1 wherein storing includes storing, for each of the plurality of protected objects, information identifying one or more actions for which a principal is authorized relative to that protected object.

3. The method of claim 2 wherein storing includes storing, for each of the plurality of protected objects, information identifying the principal to which authorization has been granted relative to that protected object.

4. A computer-readable medium having stored thereon a data structure, the data structure including a plurality of entries each comprising:
a first data field containing data identifying a protected object; and
a second data field containing data representing at least one action for which a principal has been authorized relative to the protected object identified in the first data field of such entry.

5. The computer-readable medium of claim 4, wherein each of the plurality of entries further comprises a third data field containing data identifying the principal authorized to perform the action represented in the second data field of such entry.

6. The computer-readable medium of claim 4, wherein the plurality of entries include at least a first entry and a second entry, and wherein the protected object identified in the first data field of the first entry is different than the protected object identified in the first data field of the second entry.

7. The computer-readable medium of claim 4, wherein the data structure is configured such that one more additional entries can be dynamically added to the data structure.

8. A method for controlling access to functionality in an application program, the method comprising:
registering at least one permission set within the application program, the permission set including a plurality of privileged actions relating to a functional category of the application program;
receiving information granting a principal authorization to at least one of the privileged actions in the permission set; and
performing said at least one of the privileged actions in accordance with the received information when initiated by the principal.

9. The method of claim 8 further comprising storing the received information in a table.

10. The method of claim 9 wherein the table includes a first data field for identifying the permission set, a second data field for identifying the principal, and a third data field for identifying said at least one of the privileged actions for which the principal is authorized.

11. The method of claim 8 wherein performance of said at least one of the privileged actions requires access to a plurality of objects.

12. The method of claim 8 wherein the permission set includes substantially all privileged actions supported by the application program.

13. The method of claim 8 wherein the permission set includes substantially all privileged actions supported by a component of the application program.

14. The method of claim 13 wherein said component is an add-in component.

15. The method of claim 14 wherein the permission set includes substantially all privileged actions supported by a plurality of add-in components of the application program.

16. A computer-readable medium having stored thereon a data structure, the data structure including a plurality of entries each comprising:
a first data field containing data identifying a permission set, said permission set defining a plurality of privileged actions relating to a functional category of an application program; and
a second data field containing data representing at least one of the privileged actions in the permission set identified in the first data field for which a principal has been authorized.

17. The computer-readable medium of claim 16, wherein each of the plurality of entries further comprises a third data field containing data identifying the principal authorized to perform the privileged action represented in the second data field of such entry.

18. The computer-readable medium of claim 16, wherein the plurality of entries include at least a first entry and a second entry, and wherein the permission set identified in the first data field of the first entry is different than the permission set identified in the first data field of the second entry.

19. The computer-readable medium of claim 18, wherein the data structure is configured such that one more additional entries can be dynamically added to the data structure.

20. A computer readable medium having stored thereon a data structure, the data structure including a plurality of entries each comprising:
a first data field containing data identifying one of a protected object and a permission set which defines a plurality of privileged actions relating to a functional category of an application program;
a second data field containing data representing at least one privileged action for which a principal has been authorized relative to said one of the protected object and the permission set identified in the first data field of such entry.

21. The computer-readable medium of claim 20, wherein each of the plurality of entries further comprises a third data field containing data identifying the principal authorized to perform the privileged action represented in the second data field of such entry.

22. A computerized method for providing at least one principal categorical privileges for executing actions within an application program, the method comprising:
receiving information authorizing the principal to perform at least one privileged action with respect to a predefined functional category of the application program, wherein performance of the privileged action requires access to objects;
storing the received authorization information; and
permitting access to the multiple objects in accordance with the stored authorization information when performance of the privileged action is initiated by the principal.
